(19) United States
(12) Patent Application Publication
(10) Pub. No.: US 2025/0156835 A1
(43) Pub. Date: May 15, 2025

(54) DEPOSIT AVAILABILITY SCHEDULE

(71) Applicant: Capital One Services, LLC, McLean, VA (US)

(72) Inventors: Keegan FRANKLIN, Tucson, AZ (US); Aeman JAMALI, Indianapolis, IN (US); Christopher GREGORY, Frederick, MD (US); Jordan ARRIETA, Wilmington, DE (US); Ashton WEBSTER, Alexandria, VA (US); Jeffrey OZIMEK, Reston, VA (US); Tabot ARREYTAMBE, Brunswick, MD (US); James BRIGHTER, Reston, VA (US); Megan OBRIEN, New Orleans, LA (US); Danielle WEGRZYN, Bear, DE (US); John MAILLETT, Arlington, VA (US); Ashay SHETH, New York, NY (US); Bach Viet NGUYEN, Vienna, VA (US); Michael CROGHAN, Herndon, VA (US); Jane JUSTIZ, McLean, VA (US); Jillian PEIFER, Sterling, VA (US); Kai SI, Monterey, CA (US); Sasha AHRESTANI, Philadelphia, PA (US); Suranya Jayan SCHOTT, Vienna, VA (US); Keane ELLIS, Kelso, WA (US)

(73) Assignee: Capital One Services, LLC, McLean, VA (US)

(21) Appl. No.: 18/509,748

(22) Filed: Nov. 15, 2023

(51) Int. Cl. G06Q 20/32; G06Q 20/04

(52) U.S. Cl. CPC G06Q 20/3223; G06Q 20/042

(57) ABSTRACT

Disclosed herein are system, apparatus, device, method and/or computer program product embodiments for providing a mid-stream deposit availability schedule to a customer electronically depositing a check. The deposit availability schedule is generated by activating a mobile financial application, receiving a customer request to deposit a financial instrument, and based on the customer request, activating a camera on the client mobile device to access a field of view of at least one camera and capture one or more images of a financial instrument, store, in a computer memory on the client mobile device, the one or more images. An optical character recognition program, resident on the client mobile device, extracts in real-time, one or more data fields from one or more portions of the financial instrument, communicates the one or more data fields to a remote deposit server and receives a deposit availability schedule, before acceptance of the remote deposit.

### BACKGROUND

As financial technology evolves, banks, credit unions and other financial institutions have found ways to make online banking and digital money management more convenient for customers. Mobile banking apps may let you check account balances and transfer money from your mobile device. In addition, a customer may deposit paper checks from virtually anywhere using their smartphone or tablet. However, customers may be surprised “post deposit” to learn of funds availability restrictions.

In the various embodiments and aspects disclosed herein, the technology disclosed herein may implement fraud controls that will return a specific flag if the customer is eligible for this experience. If they are eligible, the funds availability schedule will be shown on the UI of the app. If not, they may receive a standard message, such as, “funds are usually available next business day”.

### BRIEF DESCRIPTION OF THE DRAWINGS

The accompanying drawings are incorporated herein and form a part of the specification.

FIG. 1 illustrates an example remote deposit check capture, according to some embodiments and aspects.

FIG. 2 illustrates example remote deposit OCR segmentation, according to some embodiments and aspects.

FIG. 3 illustrates an example flow diagram of a funds availability system, according to some embodiments and aspects.

FIG. 4 illustrates a block diagram of a funds availability system, according to some embodiments and aspects.

FIG. 5 illustrates another example diagram of a ML funds availability system, according to some embodiments and aspects.

FIG. 6 illustrates a flow diagram for a funds availability system, according to embodiments and aspects.

FIG. 7 illustrates an example computer system useful for implementing various embodiments and aspects.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method and/or computer program product embodiments, and/or combinations and sub-combinations thereof for providing a mid-stream funds availability schedule to a customer electronically depositing a check.

A mobile check deposit is a fast, convenient way to deposit funds using a customer's mobile device. As financial technology and digital money management tools continue to evolve, the process has become safer and easier than ever before. Mobile check deposit is a way to deposit a paper check through a customer's mobile banking app using a smartphone or tablet. A mobile deposit allows the customer to capture a picture of the check using, for example, their smartphone or tablet camera and process it through the mobile banking app running on the mobile device. Deposits commonly include, but are not limited to, personal, business or government checks.

Currently, computer-based (e.g., laptop) or mobile-based (e.g., mobile device) technology allows a customer to initiate a document uploading process for uploading images or other electronic versions of a document to a backend system (e.g., a document processing system) for various purposes. In some cases, this technology prevents actions from being performed during the document upload process, i.e., while the document is being uploaded and processed by the backend system. That is, once the customer initiates the document upload process, the process will continue until completion without providing any opportunities for the customer to make any mid-stream adjustments to the process. This restrictive approach is necessitated in certain document upload processes because such processes have automated routines for receiving the images, processing the images, and completing actions associated with the upload of the images. For example, a customer may utilize a mobile deposit application to upload a document associated with a customer account, such as a check associated with the customer's bank account. Once initiated, the document upload process continues until the check has been uploaded without any further input from the customer. This current process is problematic because a customer cannot cancel or otherwise make changes to the upload process as it is occurring. Moreover, the customer is typically not given any information about the upload process until after the process has completed when it is too late to cancel or otherwise make changes to the upload.

Most banks and financial institutions use advanced security features to keep an account safe from fraud during the mobile check deposit workflow. For example, security measures may include encryption and device recognition technology. In addition, mobile check applications typically capture the check deposit information without permanently storing the photos on the customer's mobile device (e.g., smartphone). Mobile check deposit may also eliminate or reduce typical check fraud as a thief of the check may not be allowed to subsequently make use of an already electronically deposited check, whether it has cleared or not and may provide an alert to the banking institution of a second deposit attempt. In addition, fraud controls may include mobile security alerts, such as mobile security notifications or SMS text alerts, which can assist in uncovering or preventing potentially fraudulent activity.

Currently, mobile check deposits are limited to a delay in funds availability or may include a limited funds availability over a scheduled time period. For example, a first, second and third portion are available over time (e.g., 48 hours). In some cases, the customer may be limited on how much they can deposit per transaction, or how much on a daily, weekly or monthly basis.

The technology described herein in the various embodiments and aspects implements a dynamic pre-deposit funds availability schedule generated by a machine-learning (ML) platform. A pre-deposit fund availability schedule allow customers to see their exact deposit fund release schedule before they complete the transaction. This eliminates problems associated with funds availability that are provided post-deposit. These problems are typically revealed by cancellations, additional requests to expedite the deposit, or duplicate check deposit when a customer deposits the check at another financial institution causing a fraud issue.

In the various embodiments and aspects disclosed herein, the technology disclosed herein may track if a deposit was then successful to determine if a deposit was actually completed once the funds availability schedule was shown to the customer or if the customer abandoned the remote deposit workflow. This tracking feature may be used as feedback to continuously update a ML funds availability model.

In the various embodiments and aspects disclosed herein, real-time Optical Character (OCR) implements an OCR of check imagery locally on the mobile device mid-experience instead of after submission. OCR is the electronic or mechanical conversion of images of typed, handwritten or printed text into machine-encoded text, whether from a scanned document, a photo of a document, a scene photo, etc. Utilizing this capability, the OCR data (e.g., check amount, signature, MICR line, account number, etc.) is communicated to a funds availability ML model to compute a funds availability schedule for that specific deposit and return it to the customer's mobile device in real-time after the check images are captured, but before the deposit has been completed. Therefore, implementing the technology disclosed herein, the funds availability schedule will now be provided to a mobile banking app and rendered on a user interface (UI) mid-experience thus allowing the customer flexibility in depositing a check. The phrase “funds availability” may be interchangeable with the phrase “deposit availability” throughout the disclosure and drawings figures.

In various embodiments and aspects disclosed herein, the OCR process may be implemented with an active OCR process. However, other known and future OCR applications may be substituted without departing from the scope of the technology disclosed herein. Active OCR is further described in U.S. application Ser. No. 18/503,778, entitled “Active OCR,” filed Nov. 7, 2023, and incorporated by reference in its entirety. Active OCR performs OCR processing on image objects formed from a live stream of image data originating from an activated camera on a client device. The image objects may capture portions of a check or an entire image of the check. As a portion of a check image is formed into a byte array, it may be provided to the active OCR system to extract any data fields found within the byte array in real-time or near real-time.

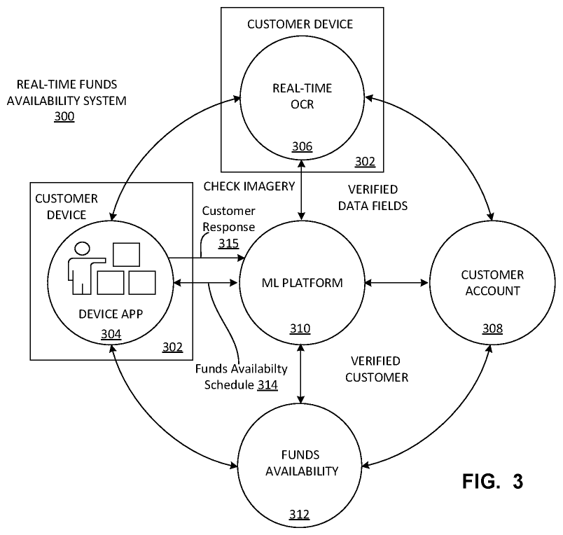

Various aspects of this disclosure may be implemented using and/or may be part of a funds availability system shown in FIGS. 3-5. It is noted, however, that this environment is provided solely for illustrative purposes, and is not limiting. Aspects of this disclosure may be implemented using and/or may be part of environments different from and/or in addition to the funds availability system, as will be appreciated by persons skilled in the relevant art(s) based on the teachings contained herein. For example, the ML aspects and processes described hereafter may be implemented locally on the customer's mobile device as part of or in addition to the mobile banking app. Alternatively, or in addition to, ML funds availability model training may be performed remotely from the customer's mobile device, but a fully trained model implemented on the mobile device. An example of the funds availability system shall now be described.

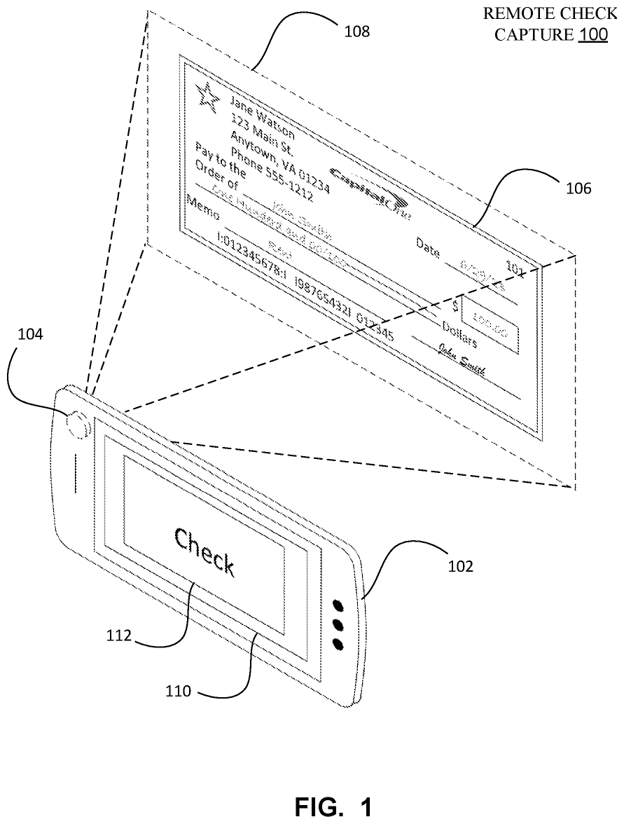

FIG. 1 illustrates an example remote check capture 100, according to some embodiments and aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 1, as will be understood by a person of ordinary skill in the art.

Sample check 106, may be a personal check, paycheck, or government check, to name a few. In some embodiments, a customer will initiate a remote deposit check capture from their mobile computing device (e.g., smartphone) 102, but other digital camera devices (e.g., tablet computer, personal digital assistant (PDA), desktop workstations, laptop or notebook computers, wearable computers, such as, but not limited to, Head Mounted Displays (HMDs), computer goggles, computer glasses, smartwatches, etc., may be substituted without departing from the scope of the technology disclosed herein. For example, when the document to be uploaded is personal check, the customer will select a customer account at the bank account (e.g., checking or savings) into which the funds specified by the check are to be deposited. Content associated with the document include the funds or monetary amount to be deposited to the customer account, the issuing bank, the routing number, and the account number. Content associated with the customer account may include a risk profile associated with the account and the current balance of the account. Options associated with a check upload process may include continuing with the upload process or cancelling the upload process (and thereby cancelling depositing the check into the account).

Mobile computing device 102 may communicate with a bank or third party using a communication or network interface (not shown). Communication interface may communicate and interact with any combination of external devices, external networks, external entities, etc. For example, communication interface may allow mobile computing device 102 to communicate with external or remote devices over a communications path, which may be wired and/or wireless (or a combination thereof), and which may include any combination of LANs, WANs, the Internet, etc. Control logic and/or data may be transmitted to and from mobile computing device via a communication path that includes the Internet.

In an example approach, a customer will login to their mobile banking app, select the account they want to deposit a check into, then select, for example, a “deposit check” option that will activate their mobile device's camera 104 (e.g., open a camera port). One skilled in the art would understand that variations of this approach or functionally equivalent alternative approaches may be substituted to initiate a mobile deposit.

Using the camera 104 function on the mobile computing device 102, the customer captures an image of at least a portion of one side of a check 112. Typically, the camera's field of view 108 will include at least the perimeter of the check. However, any camera position that enables an in-focus electronic capture of the various data fields located on a check may be considered. The image capture can be achieved automatically or manually as is well known in the art. Resolution, distance, alignment and lighting parameters may require movement of the mobile device until a proper capture has been recorded. An application running on the mobile computer device may offer suggestions or technical assistance to complete a proper capture within the banking app's graphically displayed field of view window 110 displayed on a User Interface (UI) instantiated by the mobile banking app. A person skilled in the art of remote deposit check image captures would be aware of common requirements and limitations and would understand that different approaches may be required based on the environment in which the check capture occurs. For example, poor lighting or reflections may require specific alternative techniques. As such, any known or future check capture techniques are considered to be within the scope of the technology described herein.

Sample customer instructions may include, but are not limited to, “Once you've completed filling out the check information and signed the back, it's time to take a picture of your check,” “For best results, place your check on a flat, dark-background surface to improve clarity,” “Make sure all four corners of the check fit within the on-screen frame to avoid any processing holdups,” “Select the camera icon in your mobile app to open the camera,” “Once you've taken a clear photo of the front of the check, repeat the process on the back of the check,” “Review the details of your check after uploading the images and ensure that the information is correct,” “Do you accept the funds availability schedule?,” “Swipe the Slide to Deposit button to submit the deposit,” “Your deposit request may have gone through, but it's still a good idea to hold on to your check for a few days,” “keep the check in a safe, secure place until you see the full amount deposited in your account,” and “After the deposit is confirmed, you can safely destroy the check.” These instructions are provided as a sample process but may include any instructions that guide the customer through a remote deposit session.

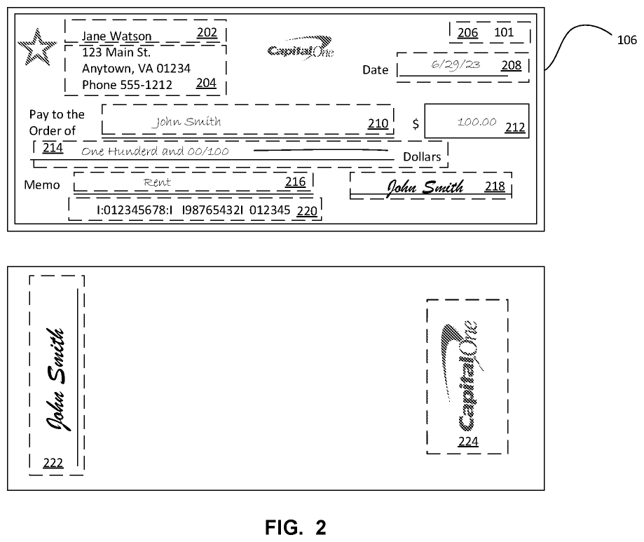

FIG. 2 illustrates example remote deposit OCR segmentation, according to some embodiments and aspects. Depending on check type, a check may have a fixed number of identifiable fields. For example, a standard personal check may have front side fields, such as, but not limited to, payer name 202 and address 204, check number 206, date 208, payee field 210, payment amount 212, a written amount 214, memo line 216, Magnetic Ink Character Recognition (MICR) line 220 that includes a string of characters including the bank routing number, the customer's account number, and the check number and finally the customer's signature 218. Back side identifiable fields may include, but are not limited to, payee signature 222 and security fields 224, such as a watermark.

While a number of fields have been described, it is not intended to limit the technology disclosed herein to these specific fields as a check may have more or less identifiable fields than disclosed herein. In addition, security measures may include alternative approaches discoverable on the front side or back side of the check or discoverable by processing of identified information. For example, the remote deposit feature in the mobile banking app running on the mobile device 102 may determine whether the payment amount 212 and the written amount 214 are the same. Additional processing may be needed to determine a final amount to process the check if the two amounts are inconsistent. In one non-limiting example, the written amount 214 may supersede any amount identified within the amount field 212.

In one embodiment, the real-time OCR of the check, implementing instructions resident on the customer's mobile device, processes each of the field locations on the check systematically. For example, the check is scanned from top to bottom and fields are identified as they are scanned. Real-time OCR or instant OCR is described in U.S. application Ser. No. 18/092,617, filed Jan. 3, 2023 and titled INSTANT OPTICAL CHARACTER RECOGNITION DURING UPLOAD PROCESS, which is incorporated by reference in its entirety. Alternatively, the entire check is captured and real-time OCR'd by instructions resident on the customer's mobile device that processes each of the field locations on the check simultaneously or in parallel.

In another embodiment, fields that include typed information, such as the MICR line 220, check number 206, payer name 202 and address 204, etc., are processed first, followed by a more complex or time intensive OCR process of identifying written fields, such as the payee field 210, signature 218, to name a few. In this and other embodiments, the more complex OCR may be performed on the bank's backend server.

In a yet another embodiment, the real-time OCR can be performed on the bank or third party server. In one implementation for initiating the real-time OCR of document images at the backend system, for example, the technology disclosed herein may dynamically add a request tag to one or more of the document images that are transmitted to the backend system with the request tag indicating that real-time OCR is to be performed. As another example, the document upload application may upload the document images and provide an OCR API (Application Programming Interface) call as separate communications to the backend system, with the OCR API call instructing the backend system to perform the OCR process immediately on the uploaded document images.

In one aspect embodiment, the mobile banking app is opened on the mobile device, the deposit check function selected, the camera is activated, the camera frame buffer populated with an image of the check, the real-time OCR performed on the data from the camera frame buffer while on the mobile device, and the identified fields communicated to the ML platform for mid-deposit funding schedule generation. It is to be appreciated that not all operations may be needed to perform the disclosure provided herein. Further, some of the operations may be performed simultaneously, or in a different order than described.

In one aspect, the front side imagery is processed followed by the back side imagery. Alternatively, or in combination, the front side and back side imagery is captured, stored and then processed together.

In some embodiments, the ML Platform 310, as described in FIGS. 3-5, may be used to train and implement OCR processing. In a non-limiting example, computer vision algorithms may use large language models (LLM). A large language model is a language model characterized by emergent properties enabled by its large size. As language models, they work by taking an input text and repeatedly predicting the next token or word. They are built with artificial neural networks, pre-trained using self-supervised learning and semi-supervised learning, typically containing tens of millions to billions of weights. In some aspects, LLM includes Natural Language Processing (NLP). Natural language processing is an interdisciplinary subfield of linguistics, computer science, and artificial intelligence concerned with the interactions between computers and human language, in particular how to program computers to process and analyze large amounts of natural language data. The goal is a computer capable of “understanding” the contents of images, including the contextual nuances of the language within them. The technology can then accurately extract information and insights contained in the images as well as categorize and organize the images or fields within images themselves.

Therefore, the technology described herein solves one or more technical problems that exist in the realm of online computer systems and in particular, with automated document upload processes that typically prevent a customer from making changes to the process once it is has been initiated. This problem is rooted in the typical communications between a document upload application installed on a customer equipment and a backend system where the upload process and subsequent processing only occur after receiving customer input via the document upload application. Another problem is that, once initiated, the document upload process continues unabated until the backend system completes the upload process as well as any additional processing (e.g., funds availability). The technology as described herein provides an improvement in the communications between the document upload application and the backend system and enables customers to make mid-stream adjustments to the upload process. One or more solutions described herein are necessarily rooted in computer technology through the modification of communications between the document upload application and the backend system. The technology described herein reduces or eliminates the problem of conventional document upload processes as will be described in the various embodiments herein.

FIG. 3 illustrates an example flow diagram of a real-time funds availability system, according to some embodiments and aspects. The real-time funds availability system 300 may include one or more system servers processing banking deposit operations in a secure closed loop. These system servers may operate to support mobile computing devices from the cloud. It is noted that the structural and functional aspects of the system servers may wholly or partially exist in the same or different ones of the system servers or on the mobile device itself. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 3, as will be understood by a person of ordinary skill in the art.

Real-time funds availability system 300 receives a camera captured check image from a customer's mobile device. For example, a customer of a mobile computing device, operating a mobile banking app 304, captures one or more images of at least a portion of a check with a camera on their mobile computing device, temporarily stores the imagery in local memory (e.g., frame buffer) and processes the captured imagery in real-time using a mobile computing device resident OCR system 306. Alternatively, the camera can be remote to the mobile computing device. In an alternative embodiment, the remote deposit is implemented on a desktop computing device. Real-time OCR is defined as performing OCR within a current customer transaction time period. For example, the OCR process is completed before finalization of a remote deposit operation.

In one non-limiting example aspect, single identifiable fields, such as the check field 206, date field 208, payee field 210, amount field 212, etc. are sequentially processed by the real-time OCR system 306. Alternatively, or in addition to, all identifiable check fields are processed simultaneously by the real-time OCR system 306. In one aspect, as illustrated, the real-time OCR system is resident on the mobile device 302. Alternatively, or in addition to, imagery of selective data fields are communicated wirelessly to a remote cloud based OCR system. For example, identifiable fields are captured substantially within expected physical locations (e.g., boxes) on the front or back side of the check. In a non-limiting example, pixels from a mobile device camera frame buffer, that include a perimeter of an expected customer's signature 218, or slightly outside of the perimeter of the box (e.g., some signatures may exceed the expected perimeter), are communicated to the remote real-time OCR system 310.

Real-time OCR system 306 communicates one or more data fields extracted in the OCR operation to a ML funds availability model 312 processed by ML Platform 310. For example, Real-time OCR 306 communicates customer data (e.g., name, address, account number, bank information (e.g., routing information), check number, check amount (e.g., funding amount needed), authorization and anti-fraud information (e.g., signature verifications, watermark or other check security imagery), etc.

ML Platform 310 dynamically computes a funds availability schedule based on one or more of the received data fields, customer history received from a customer account 308, bank funding policies, legal requirements (e.g., state or federally mandated limits and reporting requirements, etc.), or typical schedules stored within a funds availability platform 312, to name a few. Customer account 308 includes, but is not limited to, a customer's financial banking information, such as individual, joint, or commercial account information, balances, loans, credit cards, account historical data, etc. The customer account 308, for purposes of description, may be the payee's account, the payer's account or both. For example, a payee's account historical information may be used to calculate a payee's funds availability schedule, while a payer's account may be checked for funds to cover the check amount. In one non-limiting example, an address may be checked against the current address found in a data file of customer account 308. In another non-limiting example, post active OCRing processing may include checking a signature file within customer account 308 to verify the payee or payer signatures. Additional known OCR post processing techniques may be substituted without departing from the scope of the technology described herein.

In a non-limiting aspect, a better customer history (e.g., larger average daily balance, higher credit history, etc.) may lead to an earlier or larger funds availability, whereas a poor customer history may represent a risk and delay or reduce funds availability. As such, based on an analysis of other customer's historical actions and funds availability calculations, a dynamically generated funds availability schedule is generated that is customized to the customer or to a customer of a similar profile. Early access to the customer's account also may also provide a verified customer for security purposes to eliminate or reduce fraud early in the remote deposit process.

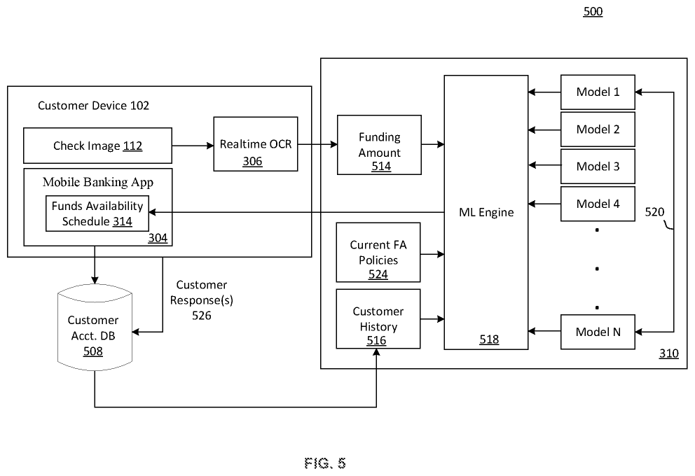

In various aspects, the funds availability schedule is generated by ML platform 310. For example, a funds availability model 520 (see FIG. 5) may be trained to process the received data fields, customer history, etc., as previously described.

ML Platform 310 communicates a funds availability schedule 314 to the customer's device. For example, the funding schedule is communicated to and rendered on-screen of a customer's device within one or more UI's of the customer device's mobile banking app. The rendering may include imagery, text, or a link to additional content. The UI may instantiate the funds availability schedule 314 as images, graphics, audio, etc. In one technical improvement over current processing systems, the funds availability schedule 314 is provided mid-stream, prior to completion of the deposit. In this approach, the customer may terminate the process prior to completion if they are dissatisfied with the funds availability schedule 314.

In one aspect embodiment, real-time funds availability system 300 tracks customer responses 315. For example, did the customer communicate their intention to complete a remote deposit operation after seeing the funds availability schedule 314 or did they cancel the request? This mid-stream customer interaction provides a technical advantage over existing systems that do not provide the customer with an ability to review an availability of their deposit in real-time, before completing their deposit transaction.

In some aspects, the completion of the remote deposit operation reflects a successful outcome, while a cancellation reflects a failed outcome. In some aspects, this customer behavior, not limited to success/failure, may be fed back to the ML platform 310 to enhance future training of the ML funding models 520 (1-N). For example, in some embodiments, one or more inputs to the ML funding models may be weighted differently (higher or lower) to effect a predicted higher successful outcome.

Alternatively, or in addition to, one or more components of the funds availability system may be implemented within the customer device, third party platforms, a cloud-based system, or distributed across multiple computer-based systems.

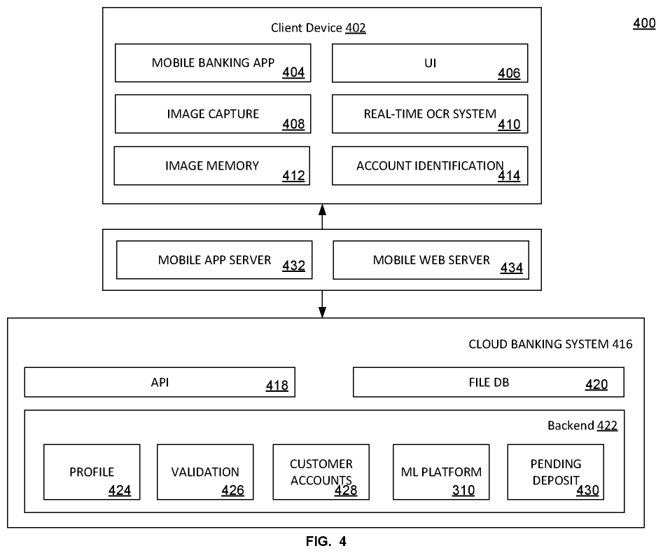

FIG. 4 illustrates a funds availability system architecture 400, according to some embodiments and aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 4, as will be understood by a person of ordinary skill in the art.

As described throughout, a client device 402 (e.g., mobile computing device 102) implements remote deposit processing for one or more financial instruments, such as checks. The client device 402 is configured to communicate with a cloud banking system 416 to complete various phases of a remote deposit as will be discussed in greater detail hereafter.

In aspects, the cloud banking system 416 may be implemented as one or more servers. Cloud banking system 416 may be implemented as a variety of centralized or decentralized computing devices. For example, cloud banking system 416 may be a mobile device, a laptop computer, a desktop computer, grid-computing resources, a virtualized computing resource, cloud computing resources, peer-to-peer distributed computing devices, a server farm, or a combination thereof. Cloud banking system 416 may be centralized in a single device, distributed across multiple devices within a cloud network, distributed across different geographic locations, or embedded within a network. Cloud banking system 416 can communicate with other devices, such as a client device 402. Components of cloud banking system 416, such as Application Programming Interface (API) 418, file database (DB) 420, as well as backend 422, may be implemented within the same device (such as when a cloud banking system 416 is implemented as a single device) or as separate devices (e.g., when cloud banking system 416 is implemented as a distributed system with components connected via a network).

Mobile banking app 404 is a computer program or software application designed to run on a mobile device such as a phone, tablet, or watch. However, in a desktop application, the mobile banking app may be configured to run on desktop computers, and web applications, which run in mobile web browsers rather than directly on a mobile device. Apps are broadly classified into three types: native apps, hybrid and web apps. Native applications are designed specifically for a mobile operating system, typically iOS or Android. Web apps are written in HTML5 or CSS and typically run through a browser. Hybrid apps are built using web technologies such as JavaScript, CSS, and HTML5 and function like web apps disguised in a native container.

Image capture 408 includes camera based captures, including, but not limited to, images, video, image or video streams or a combination of any of these or future image formats. The image capture for remote deposit captures imagery of financial instruments, such as checks. For example, one or more check images of a check 106 may be captured for an electronic remote deposit. A customer of a client device 402, operating a mobile banking app 404 through an interactive UI 406, captures one or more images of at least a portion of a check (e.g., identifiable fields on front or back of check) with a camera. The images are stored (e.g., at least temporarily) in computer memory. For example, check images are stored locally in image memory 412, such as, but not limited to, a frame buffer, a video buffer, a streaming buffer, or a virtual buffer.

Real-time OCR system 410 (consistent with 306), resident on the client device 402, processes the captured and stored imagery to extract data from the imagery by identifying specific data located within known sections of the check to be electronically deposited. In one non-limiting example aspect, single identifiable fields, such as the payer name 202, MICR data field 220 identifying customer and bank information (e.g., bank name, bank routing number, customer account number, and check number), date field 208, check amount 212 and written amount 214, and authentication (e.g., payee signature 222) and anti-fraud 224 (e.g., watermark), etc. are sequentially processed by the real-time OCR system 410. Alternatively, or in addition to, all identifiable check fields are processed simultaneously by the real-time OCR system 410. In some aspects disclosed herein, the OCR process is completed before finalization of a remote deposit operation. In one non-limiting example, identifiable fields are captured substantially within expected physical locations (e.g., boxes) on the front or back side of the check. In another non-limiting example, pixels from a mobile device camera frame buffer, that include a perimeter of an expected signature 218 box, or slightly outside of the perimeter of the box (e.g., some signatures may exceed the expected perimeter), are communicated to the remote real-time OCR system 306.

In one aspect, as illustrated, the real-time OCR system 410 is resident on the client device 402. Alternatively, or in addition to, captured imagery of a financial instrument is communicated to a cloud based system 416 or to a separate third party for real-time OCR.

Account identification 414 uses single or multiple level login data from Mobile banking app 404 singular or in combination with customer identifier information extracted during the real-time OCR process to identify a customer's account.

Real-time OCR system 410 communicates data extracted from the one or more data fields during the real-time OCR operation to cloud banking system 416. For example, the extracted data identified within these fields is communicated to file database (DB) 420 either through a mobile app server 432 or mobile web server 434 depending on the client device (e.g., mobile or desktop).

Backend 422, may include one or more system servers processing banking deposit operations in a secure closed loop. These one or more system servers operate to support client device 402. API 418 is an intermediary software interface between mobile banking app 404, installed on client device 402, and one or more server systems, such as, but not limited to the backend 422, as well as third party servers (not shown). The API 418 is available to be called by mobile clients through a mobile edge server (not shown) within cloud banking system 416. File DB stores files received from the client device 402 or generated as a result of processing a remote deposit.

Profile module 424 retrieves customer profiles associated with the customer from a registry after extracting customer data from front or back images of the financial instrument. Customer profiles may be used to determine deposit limits, historical activity, security data, or other customer related data.

Validation module 426 generates a set of validations including, but not limited to, any of: mobile deposit eligibility, account, image, transaction limits, duplicate checks, amount mismatch, MICR, multiple deposit, etc. While shown as a single module, the various validations may be performed by, or in conjunction with, the client device 402, cloud banking system 416 or third party systems or data.

Customer Accounts 428 (consistent with customer account 308) includes, but is not limited to, a customer's financial banking information, such as individual, joint, or commercial account information, balances, loans, credit cards, account historical data, etc.

ML Platform 310 with a trained ML funds availability model 520, as described in greater detail in FIGS. 3 and 5, processes the extract OCR data, in conjunction with customer historical data and funds availability schedules, to dynamically generate a customer customized funds availability schedule.

When the funds availability schedule has been generated, it is passed back to the client device 402 through API 418 where it is formatted for communication and display on the client device 402 and communicates the generated funds availability schedule 314 for display or rendering on the customer's device through the mobile banking app UI 406. The UI may instantiate the funds availability schedule as images, graphics, audio, additional content, etc. In one technical improvement over current processing systems, the funds availability schedule is provided mid-stream, prior to completion of the deposit. In this approach, the customer may terminate the process prior to completion if they are dissatisfied with the funds availability schedule.

Pending deposit 430 includes a profile of a potential upcoming deposit(s) as determined by the dynamic funding schedule and an acceptance by the customer through UI 406 to accept the deposit according to the given terms. If the deposit is successful, the flow creates a record for the transaction and this function retrieves a product type associated with the account, retrieves the interactions, and creates a pending check deposit activity.

Alternatively, or in addition to, one or more components of the funds availability system may be implemented within the client device, third party platforms, the cloud-based banking system 416, or distributed across multiple computer-based systems.

FIG. 5 illustrates another example diagram of a Real-time Funds Availability System 500, according to some aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 5, as will be understood by a person of ordinary skill in the art.

Real-time funds availability system 500 may be implemented with a machine-learning platform, such as ML platform 310. Machine learning involves computers discovering how they can perform tasks without being explicitly programmed to do so. Machine learning (ML) includes, but is not limited to, artificial intelligence, deep learning, fuzzy learning, supervised learning, unsupervised learning, etc. Machine learning algorithms build a model based on sample data, known as “training data”, in order to make predictions or decisions without being explicitly programmed to do so. For supervised learning, the computer is presented with example inputs and their desired outputs and the goal is to learn a general rule that maps inputs to outputs. In another example, for unsupervised learning, no labels are given to the learning algorithm, leaving it on its own to find structure in its input. Unsupervised learning can be a goal in itself (discovering hidden patterns in data) or a means towards an end (feature learning).

A machine-learning engine may use various classifiers to map concepts associated with a specific funds availability structure to capture relationships between concepts (e.g., risk vs. funds made available vs. time) and the customer's history (e.g., as found in a customer profile). The classifier (discriminator) is trained to distinguish (recognize) variations. Different variations may be classified to ensure no collapse of the classifier and so that variations can be distinguished.

Machine learning may involve computers learning from data provided so that they carry out certain tasks. For more advanced tasks, it can be challenging for a human to manually create the needed algorithms. This may be especially true of teaching approaches to correctly identify customer risk patterns and associated future risk. The discipline of machine learning therefore employs various approaches to teach computers to accomplish tasks where no fully satisfactory algorithm is available. In cases where vast numbers of potential answers exist, one approach, supervised learning, is to label some of the correct answers as valid. This may then be used as training data for the computer to improve the algorithm(s) it uses to determine correct answers.

In some aspects, machine learning models are trained with other customer's historical information (e.g., previous financial interactions, such as, credit scores, account balances, transactions, such as, bouncing a check, etc.). In addition, large training sets of the other customer's historical information may be used to normalize prediction data (e.g., not skewed by a single or few occurrences of a data artifact). Thereafter, the predictive models 520 may classify a specific customer's historic data based on a positive interaction with generated personalized funds availability schedules or by negative labels (e.g., no interaction, etc.) against the trained predictive model to predict preferences and generate or enhance a previous generated query based on a customer profile and provided metadata. In one embodiment, the ML models (e.g., models 520, 1-N) are continuously updated as new customer profile financial interactions occur.

Customer Account DB 508 may provide customer profile information that may be used with the ML platform 310 to provide account and profile information based on associated identifiers (IDs). Additionally, as specific funds availability schedules 314 are presented to the customer, for example, as rendered on their customer device 302 through mobile banking app 304, the historical information may be added to the customer's profile and further be stored in the customer profile DB 508.

As shown, a series of desired models 520, 1-N, may be fed into the ML Engine 518 as predictor models to select a model that may be based on the check extracted data (e.g., amount), a customer's profile (e.g., credit history), known funds availability schedules, to name a few. The predictor models seek to predict a model that will increase customer interactions with the generated funds availability schedule.

The model(s) 520 may be trained and continuously improved by analyzing relative success over a large data set, where success is measured by a customer's interactions with the funds availability schedule 314. In one example aspect, using natural language processing, customer profiles may be parsed and a model selected based on the parsed terms. For example, models 520 may be focused to generate queries for a specific performance level, such as credit worthiness.

In some aspects, the ML engine may continuously change weighting of model inputs to increase customer interactions with the funds availability procedures. For example, weighting of specific terms, phrases or equivalents may be continuously modified in the model to trend towards greater success. Conversely, term weighting that lowers successful customer interactions may be lowered or eliminated.

In one non-limiting example operation, check image 112 is captured by a camera 104 of customer device 102, locally processed by real-time OCR to extract check data from fields of the check, such as, the funding amount 514, as determined from amount fields 212 and 214. This example uses a funding amount, but any extractable or combination of extractable fields from the check image 112 may be provided as an input to the ML engine 518. In this example, the funding amount 514 is communicated to a ML engine 518 of ML platform 310 to be used as at least one input to a selected ML model 520 (1-N). The customer history from the customer account DB 508 may also be an input to the ML engine. Known funding availability schedules based on Funding Availability Policies 524, may also be an input to ML engine 518. A funds availability model processes a dynamically selectable weighting of these inputs and generates funds availability schedule 314 that is returned to the customer device 102. Customer behaviors or interactions 526 with the generated funds availability schedule 314 are fed back to the ML engine 518 directly (not shown) or through an update of customer history 516 as stored in customer account DB 508 to provide continuous training of one or more of the funds availability models 520 (1-N).

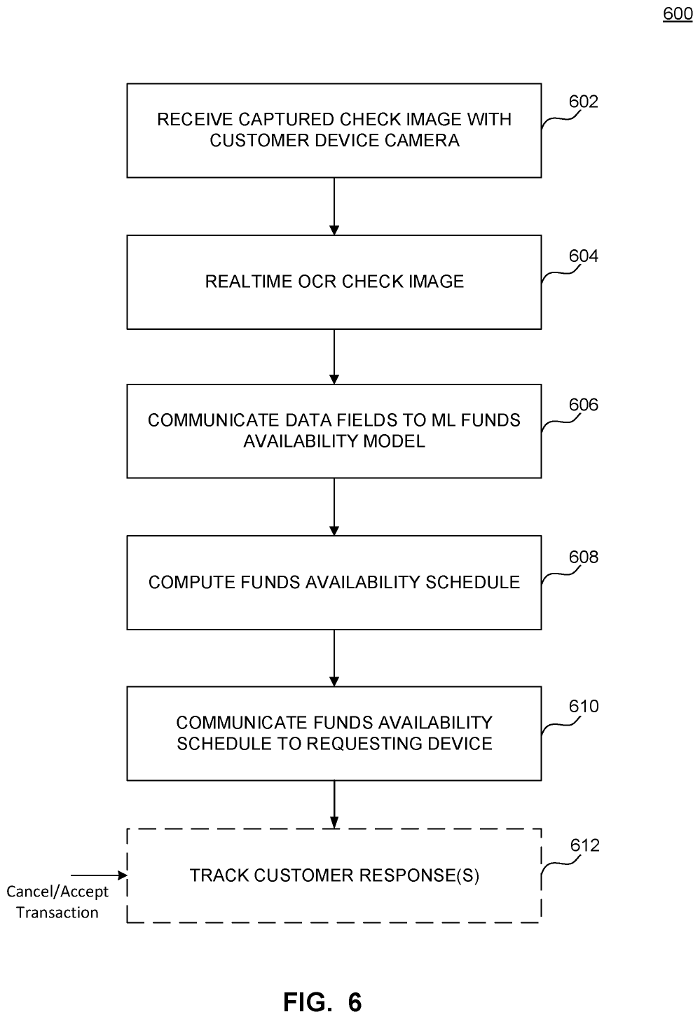

FIG. 6 is a flow chart 600 depicting a real-time funding schedule method that can be carried out in line with the discussion above. One or more of the operations in the method depicted by FIG. 6 could be carried out by one or more entities, including, without limitation, ML platform 310, customer device 302 or other server or cloud-based server processing systems and/or one or more entities operating on behalf of or in cooperation with these or other entities. Any such entity could embody a computing system, such as a programmed processing unit or the like, configured to carry out one or more of the method operations. Further, a non-transitory data storage (e.g., disc storage, flash storage, or other computer readable medium) could have stored thereon instructions executable by a processing unit to carry out the various depicted operations. In some aspects, the systems described generate and instantiate a real-time funding schedule for a mobile computing device app.

In 602, real-time funding schedule system 300 receives and stores a captured check image captured with a customer device 102. For example, a customer of a mobile computing device, operating a mobile banking app, captures one or more images of a check with a camera on their mobile computing device and communicates it to a resident real-time OCR system 306.

In 604, real-time funding schedule system 300, based on the one or more received check images, performs real-time OCR on the received image(s). Real-time OCR is defined as performing OCR within a current customer transaction time period. For example, the OCR process is completed before finalization of a remote deposit operation.

In 606, real-time funding schedule system 300 communicates one or more data fields extracted in the OCR operation to a ML funds availability model processed by ML Platform 310. For example, Real-time OCR 306 communicates customer data (e.g., name, address, account number, bank information (e.g., routing information), check number, check amount (e.g., funding amount needed), authorization and anti-fraud information (e.g., signature verifications, watermark or other check security imagery), etc.

In 608, real-time funding schedule system 300 dynamically computes a funds availability schedule based on one or more of the received data fields, customer history, bank funding policies, legal requirements (e.g., state or federally mandated limits and reporting requirements, etc.), to name a few. In various aspects, the funds availability schedule is generated by ML platform 310. For example, a funds availability model 520 may be trained to process the received data fields, customer history, known funds availability schedules, etc., as previously described.

In 610, real-time funding schedule system 300 communicates the funds availability schedule 522 to the customer's device. For example, the funding schedule is communicated to and rendered on-screen of a customer's device within one or more customer UI's of the customer device's mobile banking app. The UI may instantiate the funds availability schedule 522 as images, graphics, audio, additional content, etc.

In 612, the real-time funding schedule system 300 optionally tracks customer responses. For example, did the customer accept the deposit availability schedule complete a remote deposit operation after seeing the funds availability schedule 522 or did they cancel the request? In some aspects, the completion of the remote deposit operation reflects a successful outcome, while a cancellation reflects a failed outcome. In some aspects, this customer response, not limited to success/failure, may be fed back to the ML platform 310 to enhance future training of the ML funding models 520 (1-N). For example, in some embodiments, one or more inputs to the ML funding models may be weighted differently (higher or lower) to effect a predicted higher successful outcome.

Alternatively, or in addition to, one or more components of the funds availability system may be implemented within the customer's mobile device, third party platforms, a cloud-based system, or distributed across multiple computer-based systems.

The solutions described above join several key technical components that are lacking in the current remote deposit funding alerts. The various aspects solve at least the technical problem of calculating a funding schedule pre-deposit. The various embodiments and aspects described by the technology disclosed herein are able to provide a customer's funds availability (FA) schedule mid-experience, before the customer completes the deposit. This timing sequence is based on a ML platform funds availability schedule calculator implemented by one or more ML trained funding models.

### Example Computer System

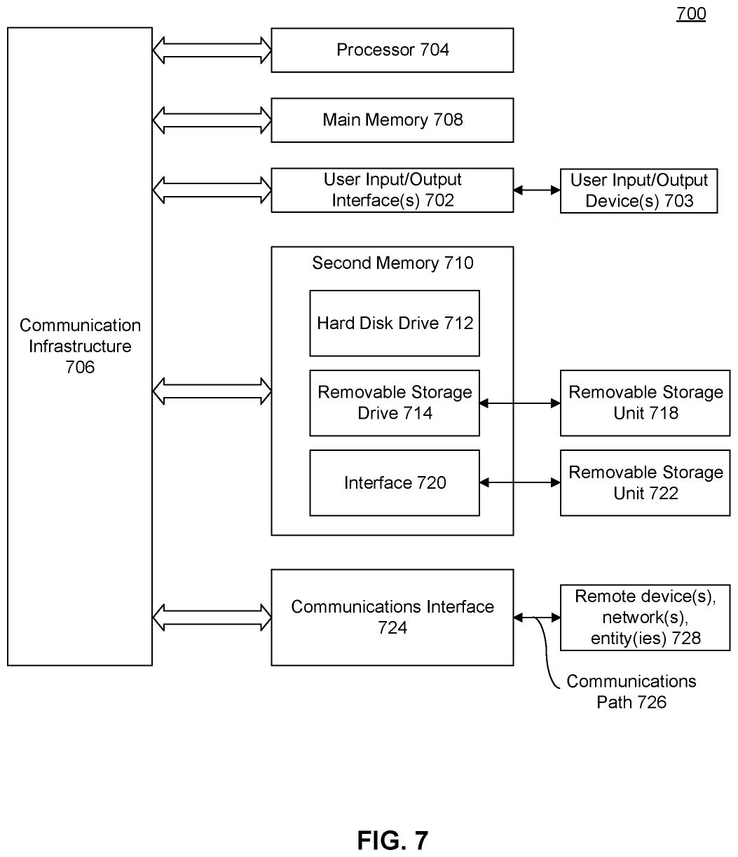

FIG. 7 depicts an example computer system useful for implementing various embodiments. For example, the example computer system may be implemented as part of mobile computing device 102 or banking system 406. Cloud implementations may include a plurality of the example computer systems locally or distributed across one or more server sites.

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include customer input/output device(s) 703, such as monitors, keyboards, pointing devices, etc., which may communicate with communication infrastructure 706 through customer input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML Customer Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

1. A computer implemented method for a remote deposit environment, comprising:
activating, on a client mobile device, a mobile financial application, wherein the client mobile device is configured to instantiate a user interface (UI);
receiving a customer request, based on interactions with the UI, to deposit a financial instrument;
based on the customer request, activating a camera on the client mobile device, wherein the camera provides access to a field of view;
capturing, by the camera and based on customer interactions with the UI, one or more images of a financial instrument;
storing, in a computer memory on the client mobile device, the one or more images;
extracting in real-time, by an optical character recognition (OCR) program resident on the client mobile device, a funding amount from one or more portions of the financial instrument;
communicating, by the client mobile device, the funding amount to a remote machine-learning engine with a deposit availability machine-learning model, wherein the deposit availability machine-learning model is initially trained by other customer historic data, including at least previous financial transactions;
generating, by the deposit availability machine-learning model and based on the funding amount and a user profile, a customized deposit availability schedule displayable on the UI;
prior to transmitting the one or more images to a remote deposit server for the remote deposit of the financial instrument, terminating remote processing of the remote deposit when a state of the remote deposit indicates a customer did not confirm a desire to deposit the financial instrument; and
communicating, to the machine-learning engine and based on the terminating remote processing, the state of the remote deposit of the financial instrument as feedback to re-train the deposit availability machine-learning model.

2. The computer implemented method of claim 1, wherein the computer memory comprises a frame buffer on the client mobile device.

3. The computer implemented method of claim 1, wherein the computer memory comprises a video buffer on the client mobile device and the one or more images comprises video.

4. (canceled)

5. The computer implemented method of claim 1, wherein the customized deposit availability schedule is dynamically variable based on any of, or a combination of: the funding amount, historical data of the customer, fraud prevention data, or historical data of previous other customers.

6. (canceled)

7. The computer implemented method of claim 1, wherein the state includes at least a state where a customer acceptance of the deposit of the financial instrument was received.

8. (canceled)

9. A system, comprising:
a memory; and
at least one processor coupled to the memory and configured to:
activate, on a client mobile device, a mobile financial application, wherein the client mobile device is configured to instantiate a user interface (UI);
receive a customer request, based on interactions with the UI, to deposit a financial instrument;
based on the customer request, activating a camera on the client mobile device, wherein the camera provides access to a field of view;
capture, by the camera and based on customer interactions with the UI, one or more images of a financial instrument;
store, in a computer memory on the client mobile device, the one or more images;
extract in real-time, by an optical character recognition (OCR) program resident on the client mobile device, a funding amount from one or more portions of the financial instrument;
communicate, by the client mobile device, the funding amount to a remote machine-learning engine with a deposit availability machine-learning model, wherein the deposit availability machine-learning model is initially trained by other customer historic data, including at least previous financial transactions;
generate, by the deposit availability machine-learning model and based on the funding amount and a user profile, a customized deposit availability schedule displayable on the UI;
prior to transmitting the one or more images to a remote deposit server for the remote deposit of the financial instrument, terminating remote processing of the remote deposit when a state of the remote deposit indicates a customer did not confirm a desire to deposit the financial instrument; and
communicating, to the machine-learning engine and based on the terminating remote processing, the state of the remote deposit of the financial instrument as feedback to re-train the deposit availability machine-learning model.

10. The system of claim 9, wherein the computer memory comprises a frame buffer on the client mobile device.

11. The system of claim 9, wherein the computer memory comprises a video buffer on the client mobile device and the one or more images comprises video.

12. (canceled)

13. The system of claim 9, wherein the customized deposit availability schedule is dynamically variable based on any of, or a combination of: the funding amount, historical data of the customer, fraud prevention data, or historical data of previous other customers.

14. (canceled)

15. A non-transitory computer-readable device having instructions stored thereon that, when executed by at least one computing device, causes the at least one computing device to perform operations comprising:
activating, on a client mobile device, a mobile financial application, wherein the client mobile device is configured to instantiate a user interface (UI);
receiving a customer request, based on interactions with the UI, to deposit a financial instrument;
based on the customer request, activating a camera on the client mobile device, wherein the camera provides access to a field of view;
capturing, by the camera and based on customer interactions with the UI, one or more images of a financial instrument;
storing, in a computer memory on the client mobile device, the one or more images;
extracting in real-time, by an optical character recognition (OCR) program resident on the client mobile device, a funding amount from one or more portions of the financial instrument;
communicating, by the client mobile device, the funding amount to a remote machine-learning engine with a deposit availability machine-learning model, wherein the deposit availability machine-learning model is initially trained by other customer historic data, including at least previous financial transactions;
generating, by the deposit availability machine-learning model and based on the funding amount and a user profile, a customized deposit availability schedule displayable on the UI;
prior to transmitting the one or more images to a remote deposit server for the remote deposit of the financial instrument, terminating remote processing of the remote deposit when a state of the remote deposit indicates a customer did not confirm a desire to deposit the financial instrument; and
communicating, to the machine-learning engine and based on the terminating remote processing, the state of the remote deposit of the financial instrument as feedback to re-train the deposit availability machine-learning model.

16. The non-transitory computer-readable device of claim 15, wherein the computer memory comprises a frame buffer on the client mobile device.

17. The non-transitory computer-readable device of claim 15, wherein the computer memory comprises a video buffer on the client mobile device and the one or more images comprises video.

18. (canceled)

19. The non-transitory computer-readable device of claim 15, wherein the customized deposit availability schedule is dynamically variable based on any of, or a combination of: the funding amount, historical data of the customer, fraud prevention data, or historical data of previous other customers.

20. (canceled)
